(19) United States
(12) Patent Application Publication
(10) Pub. No.: US 2026/0179409 A1
(43) Pub. Date: Jun. 25, 2026

(54) ELECTRONIC DEVICE AND METHOD FOR RECOGNIZING FACE OF USER, AND COMPUTER-READABLE STORAGE MEDIUM

(71) Applicant: NCSOFT CORPORATION, Seoul (KR)

(72) Inventors: Youngbaek Kim, Seongnam-si (KR); Younghyun Lee, Seongnam-si (KR); Jaehyeop Choi, Seongnam-si (KR)

(73) Assignee: NCSOFT CORPORATION, Seoul (KR)

(21) Appl. No.: 19/535,242

(22) Filed: Feb. 10, 2026

Related U.S. Application Data
(63) Continuation of application No. PCT/KR2024/000860, filed on Jan. 17, 2024.

(51) Int. Cl. G06V 40/16; G06V 10/764; G06V 10/82

(52) U.S. Cl. CPC G06V 40/172; G06V 10/764; G06V 10/82; G06V 40/173; G06T 2207/20081

(57) ABSTRACT

This electronic device may comprise: a memory for storing instructions; and a processor. When executed by the processor, the instructions can cause the electronic device to: acquire an image that includes the face of a user; extract feature values from the acquired image by using a face recognition model to which the weight of a masked auto encoder (MAE) trained for faces including the face is transferred; identify, from among reference embedding vectors stored in the memory, a reference embedding vector corresponding to an embedding vector generated on the basis of the extracted feature values; and recognize the user corresponding to the reference embedding vector identified from the image. The face recognition model can be trained through a loss function calculated on the basis of a reference margin value and a rotation margin value, which is based on at least one rotation angle value indicating the orientation of the face.

### CROSS-REFERENCES TO RELATED APPLICATIONS

This application is a continuation of International Application No. PCT/KR2024/000860, filed on Jan. 17, 2024, at the Ministry of Intellectual Property, the disclosure of which is incorporated herein by reference in its entirety.

### TECHNICAL FIELD

Embodiments disclosed in the present disclosure relate to an electronic device, a method, and a computer readable storage medium for recognizing a face of a user.

### BACKGROUND ART

Recently, spread of various types of electronic devices such as a smartphone, a tablet PC, a wireless earphone, and/or a smart watch is expanding. These electronic devices may provide a function for performing interaction with a user based on a human machine interface (HMI). The electronic devices may provide the function via a face recognition (FR) service.

### DISCLOSURE

### Technical Problem

According to an embodiment, an electronic device may recognize a face of a user. For example, the electronic device may use a model for recognizing the face. Even when an orientation of the face is changed, the electronic device may require a method for accurately recognizing the face of the user.

The technical problems to be achieved in this document are not limited to those described above, and other technical problems not mentioned herein will be clearly understood by those having ordinary knowledge in the art to which the present disclosure belongs, from the following description.

### Technical Solution

An electronic device may comprise memory storing instructions. The electronic device may comprise a processor operatively coupled to the memory. The instructions, when executed by the processor, may cause the electronic device to obtain an image including a face of a user. The instructions, when executed by the processor, may cause the electronic device to extract feature values from the obtained image using a face recognition model such that a weight of a masked auto encoder (MAE) trained with respect to faces including the face is transitioned. The instructions, when executed by the processor, may cause the electronic device to identify a reference embedding vector, among reference embedding vectors stored in the memory, corresponding to an embedding vector generated based on the extracted feature values. The instructions, when executed by the processor, may cause the electronic device to recognize the user corresponding to the reference embedding vector identified from the image. The face recognition model may be trained via a loss function calculated based on a reference margin value and a rotation margin value based on at least one rotation angle value indicating an orientation of the face.

A method performed by an electronic device may comprise obtaining an image including a face of a user. The method may comprise extracting feature values from the obtained image using a face recognition model such that a weight of a masked auto encoder (MAE) trained with respect to faces including the face is transitioned. The method may comprise identifying a reference embedding vector, among stored reference embedding vectors, corresponding to an embedding vector generated based on the extracted feature values. The method may comprise recognizing the user corresponding to the reference embedding vector identified from the image. The face recognition model may be trained via a loss function calculated based on a reference margin value and a rotation margin value based on at least one rotation angle value indicating an orientation of the face.

In a computer readable storage medium storing one or more programs, the one or more programs, when executed by a processor of an electronic device, may comprise instructions to cause the electronic device to obtain an image including a face of a user. The one or more programs, when executed by the processor, may comprise instructions to cause the electronic device to extract feature values from the obtained image using a face recognition model such that a weight of a masked auto encoder (MAE) trained with respect to faces including the face is transitioned. The one or more programs, when executed by the processor, may comprise instructions to cause the electronic device to identify a reference embedding vector, among stored reference embedding vectors, corresponding to an embedding vector generated based on the extracted feature values. The one or more programs, when executed by the processor, may comprise instructions to cause the electronic device to recognize the user corresponding to the reference embedding vector identified from the image. The face recognition model may be trained via a loss function calculated based on a reference margin value and a rotation margin value based on at least one rotation angle value indicating an orientation of the face.

A method of training a model for recognizing a face of a user may comprise obtaining rotation angle values indicating an orientation of the face in an image of the user. The rotation angle values may include roll relative to the face, pitch relative to the face, and yaw relative to the face. The method may comprise generating an activation function relative to the sum of a first absolute value relative to the roll, a second absolute value relative to the pitch, and a third absolute value relative to the yaw. The method may comprise calculating a rotation margin value from a multiplication between the generated activation function and an additional margin value. The method may comprise calculating a loss function based on the sum of the rotation margin value and a reference margin value. The method may comprise applying the loss function to the model.

### Advantageous Effects

According to an embodiment, an electronic device can recognize a face of a user. For example, the electronic device can use a model for recognizing the face. For example, the electronic device can identify an orientation of the face related to a posture of the user. The electronic device can train the model in consideration of information on the orientation of the face. The electronic device can accurately recognize the face of the user using the trained model. The trained model can be trained to use embedding vectors of the image of the user for recognizing the face of user.

The effects that can be obtained from the present disclosure are not limited to those described above, and any other effects not mentioned herein will be clearly understood by those having ordinary knowledge in the art to which the present disclosure belongs, from the following description.

### DESCRIPTION OF THE DRAWINGS

FIG. 1 illustrates an example of a block diagram of an electronic device according to an embodiment.

FIG. 2 illustrates an example for describing a neural network obtained by an electronic device from a set of parameters stored in memory according to an embodiment.

FIG. 3A illustrates an example of a face recognition model used by an electronic device to recognize a face of a user according to an embodiment.

FIG. 3B illustrates an example of a method of recognizing a user based on a face recognition model according to an embodiment.

FIG. 4 illustrates an example of a method for recognizing a user based on a face recognition model according to an embodiment.

FIG. 5A illustrates an example of a loss function that is used for training a face recognition model and is changed according to an orientation of a face, according to an embodiment.

FIGS. 5B and 5C illustrate examples of a method of recognizing a face of a user based on a face recognition model trained using a loss function that is changed according to an orientation of a face according to an embodiment.

FIG. 6 illustrates an example of an operation flow of a method of recognizing a face of a user based on a face recognition model trained using a loss function that is changed according to an orientation of the face according to an embodiment.

FIG. 7 illustrates an example of a face recognition model having a weight transitioned from a weight of a model trained using an image restored from an image indicating a portion of a face of a user according to an embodiment.

FIG. 8 illustrates examples of an image indicating a portion of a face of a user, a restored image, and an image indicating the face of the user according to an embodiment.

### MODE FOR INVENTION

The electronic device according (or the external electronic device) to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to an embodiment of the disclosure, the electronic devices (or the external electronic device) are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “coupled to,” “connected with,” or “connected to with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 101). For example, a processor of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which where data is semi-permanently stored in the storage medium and where a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

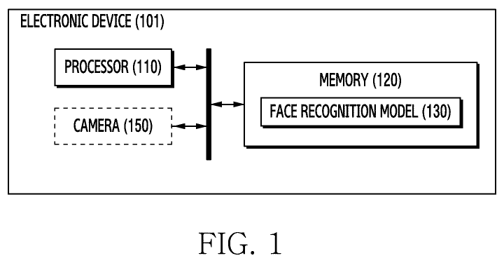

FIG. 1 illustrates an example of a block diagram of an electronic device according to an embodiment.

Referring to FIG. 1, according to an embodiment, an electronic device 101 may include a terminal owned by a user. The terminal may include a personal computer (PC) such as a laptop and a desktop, a smartphone, a smartpad, a tablet PC, a smartwatch, and a smart accessory such as a head-mounted device (HIMD).

Referring to FIG. 1, according to an embodiment, the electronic device 101 may include at least one of a processor 110, memory 120, or a camera 150. The processor 110, the memory 120, or the camera 150 may be electronically and/or operably coupled with each other by an electronic component such as a communication bus. A type and/or the number of hardware components included in the electronic device 101 are not limited to as illustrated in FIG. 1. For example, the electronic device 101 may include only a portion of hardware components illustrated in FIG. 1. Alternatively, for example, the electronic device 101 may further include another component (e.g., a display, a microphone, or a sensor) other than the hardware components illustrated in FIG. 1.

Elements (e.g., layers and/or a face recognition model 130) in memory described below may be logically divided. However, it is not limited thereto.

According to an embodiment, the processor 110 of the electronic device 101 may include a hardware component for processing data based on one or more instructions. For example, the hardware component for processing the data may include an arithmetic and logic unit (ALU), a field programmable gate array (FPGA), and/or a central processing unit (CPU). The number of the processors 110 may be one or more. For example, the processor 110 may have a structure of a multi-core processor such as a dual core, a quad core, or a hexa core.

According to an embodiment, the memory 120 of the electronic device 101 may include a hardware component for storing data and/or instructions inputted to and/or outputted from the processor 110. For example, the memory 120 may include a volatile memory such as a random-access memory (RAM), and/or a non-volatile memory such as a read-only memory (ROM). For example, the volatile memory may include at least one of a dynamic RAM (DRAM), a static RAM (SRAM), a Cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, and an embedded multi media card (eMMC).

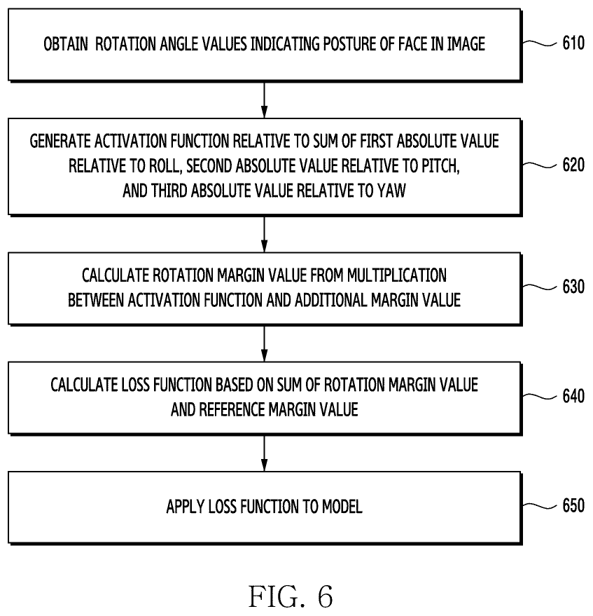

According to an embodiment, in the memory 120 of the electronic device 101, one or more instructions (or commands) indicating a calculation and/or an operation to be performed by the processor 110 of the electronic device 101 on data may be stored. A set of one or more instructions may be referred to as firmware, an operating system, a process, a routine, a sub-routine and/or an application. For example, when a set of a plurality of instructions distributed in a form of an operating system, firmware, a driver, and/or an application are executed, the electronic device 101 and/or the processor 110 may perform at least one of operations of FIG. 6. Hereinafter, an application being installed in the electronic device 101 may mean that one or more instructions provided in a form of an application are stored in the memory 120, and the one or more applications are stored in a format (e.g., a file with an extension designated by an operating system of the electronic device 101) executable by the processor 110. As an example, an application may include a program and/or a library related to a service provided to the user.

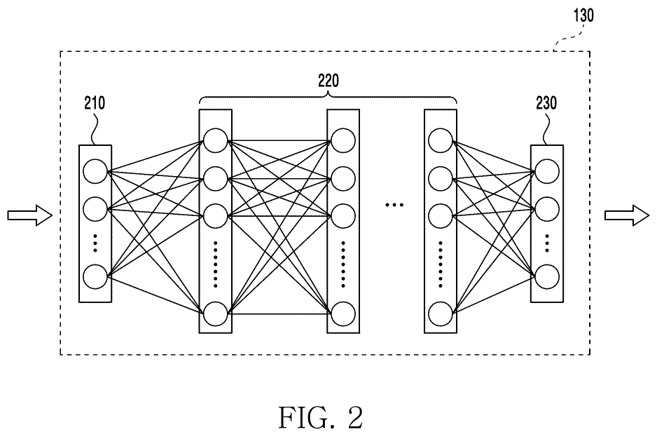

According to an embodiment, a set of parameters related to the face recognition model 130 may be stored in the memory 120 of the electronic device 101. The face recognition model 130 is a recognition model implemented in software or hardware that imitates a computational capability of a biological system using a large number of artificial neurons (or nodes). The face recognition model 130 may perform a human cognitive action or a learning process through the artificial neurons. For example, the parameters related to the face recognition model 130 may indicate a plurality of nodes included in the face recognition model 130 and/or a weight assigned to a connection between the plurality of nodes. According to an embodiment, a structure of the face recognition model 130 indicated by the set of the parameters stored in the memory 120 of the electronic device 101 will be described later through FIG. 2.

According to an embodiment, the camera 150 of the electronic device 101 may include one or more optical sensors (e.g., a charged coupled device (CCD) sensor and a complementary metal oxide semiconductor (CMOS) sensor) that generate an electrical signal indicating a color and/or brightness of light. A plurality of optical sensors included in the camera 150 may be disposed in a form of a 2-dimensional array. The camera 150 may correspond to light reaching the optical sensors of the 2-dimensional array and generate an image including a plurality of pixels arranged in two dimensions, by obtaining an electrical signal of each of the plurality of optical sensors substantially simultaneously. For example, photo data captured using the camera 150 may mean one image obtained from the camera 150. For example, the image may include a face of the user. For example, video data captured using the camera 150 may mean a sequence of a plurality of images obtained from the camera 150 according to a designated frame rate. According to an embodiment, the electronic device 101 may further include a flash light that is disposed toward a direction in which the camera 150 receives light and for outputting light in the direction. Although FIG. 1 illustrates that the electronic device 101 includes the camera 150, an embodiment of the present disclosure is not limited thereto. For example, the electronic device 101 may not include the camera 150.

In addition, although not illustrated in FIG. 1, the electronic device 101 may further include a sensor for obtaining data including the face of the user. In addition, the electronic device 101 may further include communication circuitry for obtaining an image or data including the face of the user from an external electronic device (e.g., a server). In addition, the electronic device 101 may further include a display for visually displaying a result of recognition of the face of the user. In addition, the electronic device 101 may further include a haptic module for physically notifying the result of the recognition.

FIG. 2 illustrates an example for describing a neural network obtained by an electronic device from a set of parameters stored in memory according to an embodiment.

For example, a neural network may configure a face recognition model 130. Referring to FIG. 2, at least a portion of the face recognition model 130 may include a plurality of layers. For example, the face recognition model 130 may include an input layer 210, one or more hidden layers 220, and an output layer 230. The input layer 210 may receive a vector (e.g., a vector having elements corresponding to the number of nodes included in the input layer 210) indicating input data. Signals generated in each of nodes in the input layer 210 generated by the input data may be transmitted from the input layer 210 to the hidden layers 220. The output layer 230 may generate output data of the face recognition model 130 based on one or more signals received from the hidden layers 220. Herein, the output data may include, for example, a vector having elements corresponding to the number of nodes included in the output layer 230.

Referring to FIG. 2, the one or more hidden layers 220 may be positioned between the input layer 210 and the output layer 230 and convert the input data transmitted through the input layer 210 into a value that is easy to predict. The input layer 210, the one or more hidden layers 220, and the output layer 230 may include a plurality of nodes. The one or more hidden layers 220 are not limited to an illustrated feedforward-based topology, and may be, for example, a convolution filter in a convolutional neural network (CNN) or a fully connected layer, or various types of filters or layers grouped based on a special function or feature. In an embodiment, the one or more hidden layers 220 may be layers based on a recurrent neural network (RNN) in which an output value is inputted back to a hidden layer of current time. As an example, the input layer 210, the one or more hidden layers 220, and/or the output layer 230 may be a partial layer of a transformer model. According to an embodiment, the face recognition model 130 may form a deep neural network by including the numerous hidden layers 220. Training a deep neural network is referred to as deep learning. Among nodes of the face recognition model 130, a node included in the hidden layers 220 is referred to as a hidden node.

Nodes included in the input layer 210 and the one or more hidden layers 220 may be connected to each other through a connection line having a connection weight, and nodes included in the hidden layer and the output layer may also be connected to each other through a connection line having a connection weight. Tuning and/or training the face recognition model 130 may mean changing a connection weight between nodes included in each of the layers (e.g., the input layer 210, the one or more hidden layers 220, and the output layer 230) included in the face recognition model 130. For example, the tuning of the face recognition model 130 may be performed based on supervised learning and/or unsupervised learning.

According to an embodiment, the electronic device may tune the face recognition model 130 based on reinforcement learning in unsupervised learning. For example, the electronic device may change policy information used by the face recognition model 130 to control an agent based on an interaction between the agent and an environment. The policy information is a rule in which the electronic device determines an action of the agent in the environment using the neural network, and the electronic device may change the policy information of the neural network by training the neural network based on the interaction between the agent and the environment. For example, the policy information may be changed so that the agent determines an optimal action and/or a sequence of an action for achieving an obtainable reward and/or goal. According to an embodiment, the electronic device may cause a change in the policy information by the face recognition model 130 to maximize the goal and/or the reward of the agent by the interaction.

An electronic device 101 may provide a face recognition function (or a face recognition service). For example, the electronic device 101 may recognize a user using an image or data including a face of the user. The electronic device 101 may input the image or the data to a model for face recognition (hereinafter, a face recognition model) and generate identification information (or identifier) indicating the user using a result outputted from the face recognition model. Based on the identification information, the electronic device 101 may recognize the user.

The face recognition model may extract feature values from the image (or the data) and compare similarity between a vector (or an embedding vector) generated from the extracted feature values and a reference vector (or a reference embedding vector) stored in the electronic device 101. According to a result of the comparison, the identification information may be generated. In this case, the face recognition model may be trained via a loss function that induces (or causes) a set of vectors relative to a face of the same person to be positioned (or distributed) close to each other, and a set of vectors relative to faces of different people to be positioned (or distributed) far away from each other. For example, the loss function may include a softmax loss function, a Euclidean distance based loss function, or an angular based (or cosine margin based) loss function.

For example, the angular based loss function may include an ArcFace loss function (hereinafter, ArcFace). For example, the ArcFace may be a function deformed from the softmax loss function as an example of the angular based loss function. As an example relative to the ArcFace, the following equation may be referred to.

$$L - - \frac{1}{N} {\sum }_{i = 1}^{N} log \frac{{e}^{{W}_{{y}_{i}}^{T} {x}_{i} + {b}_{{y}_{i}}}}{{\sum }_{j = 1}^{n} {e}^{{W}_{\text{?}}^{T} {x}_{i} + {b}_{\text{?}}}} \qquad [ Equation 1 ]$$

$$\text{?} \text{indicates text missing or illegible when filed}$$

The L may indicate the ArcFace, the N may indicate a batch (or a mini-batch) size (or the number of samples), the x may indicate an input vector, the b may indicate a vias vector (or a bias), the W may indicate a weight matrix for classification between embedding vectors (or identifiers), the y may indicate a correct answer class (or a label), and the n may indicate the number of the correct answer classes. The correct answer class may correspond to the number of identifiers corresponding to users classified based on the ArcFace.

Even when the electronic device 101 uses the face recognition model trained via the loss function, face recognition performance may be decreased according to an orientation of the face in an image, brightness of the image, or a degree of masking of the face in the image. For example, the face recognition performance may be decreased in a case that the face in the image faces to, other than an orientation facing a front orientation, an orientation rotated in a different orientation from the front orientation. In addition, for example, in a case that the brightness in the image is excessively dark or bright, the face recognition performance may be decreased. In addition, for example, in a case that a portion of the face is covered, such as a mask or sunglasses, the face recognition performance may be decreased. In other words, the ArcFace may apply the same margin value with respect to feature values (or a vector) extracted from the face of the inputted image without considering the orientation of the face of the user, the brightness, or the degree of masking of the face.

Hereinafter, according to embodiments of the present disclosure, the electronic device, a method, and a computer readable storage medium may use the face recognition model 130 trained via a loss function (hereinafter, an angle-aware loss function) determined based on information on an orientation of the face. According to embodiments of the present disclosure, the electronic device, the method, and the computer readable storage medium may improve the face recognition performance relative to the image including the face facing to a rotated orientation based on the face recognition model 130 using the angle-aware loss function. In addition, according to embodiments of the present disclosure, the electronic device, the method, and the computer readable storage medium may use the face recognition model 130 initialized via a weight transitioned from a weight of a pre-trained model. The pre-trained model may be trained via an image in which a portion of the face is covered or removed. In addition, according to embodiments of the present disclosure, the electronic device, the method, and the computer readable storage medium may improve face recognition performance relative to the image including a portion of the face based on the initialized face recognition model 130.

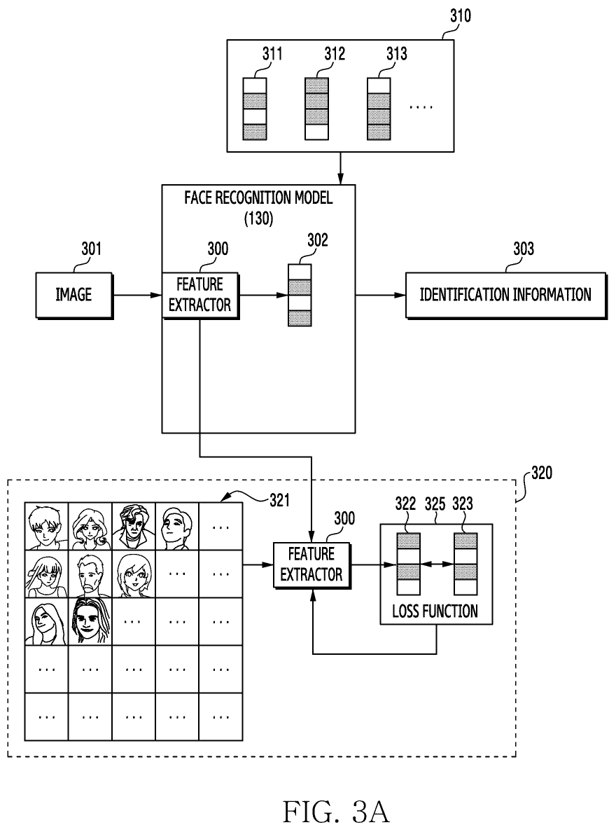

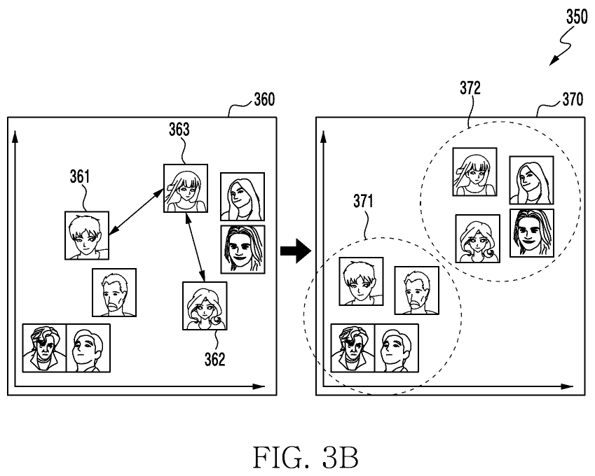

FIG. 3A illustrates an example of a face recognition model used by an electronic device to recognize a face of a user according to an embodiment.

FIG. 3A illustrates an example of a face recognition model 130 used by an electronic device 101 to obtain an image including (or indicating) the face of the user and to recognize the user from the obtained image. The face recognition model 130 of FIG. 3A may indicate an example of the face recognition model 130 of FIG. 1 and the face recognition model 130 of FIG. 2. For example, the face recognition model 130 may be referred to as a face recognition pipeline, a face recognition system, or a face recognition system pipeline. Hereinafter, operations performed by the face recognition model 130 are described, but an embodiment of the present disclosure is not limited thereto. For example, as the electronic device 101 uses the face recognition model 130 or the face recognition model 130 is controlled by a processor 110 of the electronic device 101, the operations may be performed.

Referring to FIG. 3A, the face recognition model 130 may include a feature extractor 300. According to an embodiment, the face recognition model 130 may extract (or generate) an embedding vector 302 from an image 301 including a face of a first user using the feature extractor 300. For example, the embedding vector 302 may be referred to as feature values or a query. For example, a size of the image 301 and a size of the embedding vector 302 may be determined based on the feature extractor 300.

According to an embodiment, the face recognition model 130 may compare the extracted embedding vector 302 with a reference embedding vectors 310. For example, the face recognition model 130 may calculate a similarity between the embedding vector 302 and the reference embedding vectors 310. For example, the face recognition model 130 may identify, among the reference embedding vectors 310, a reference embedding vector corresponding to the embedding vector 302 based on a result of the calculation (or the comparison). For example, the reference embedding vector corresponding to the embedding vector 302 may indicate a vector (e.g., a first reference embedding vector 311) that has the most similar value to the embedding vector 302 among the reference embedding vectors 310.

For example, the reference embedding vectors 310 may include the first reference embedding vector 311 indicating the first user, a second reference embedding vector 312 indicating a second user, and a third reference embedding vector 313 indicating a third user. However, an embodiment of the present disclosure is not limited thereto. For example, the number of the reference embedding vectors 310 may be changed. The reference embedding vectors 310 may be referred to as a gallery storing information on a user. For example, the reference embedding vectors 310 may be stored in memory 120 of the electronic device 101.

According to an embodiment, the face recognition model 130 may output identification information 303 indicated by the first reference embedding vector 311. For example, the identification information 303 may represent identification information (or an identifier) indicating the first user.

Referring to the above description, the electronic device 101 may extract feature values from the inputted image 301 using the face recognition model 130, compare the embedding vector 302 generated from the extracted feature values with the stored reference embedding vectors, and recognize a specific user based on a result of the comparison. In this case, the feature extractor 300 of the face recognition model 130 may be in a pre-trained state. A content related to learning of the feature extractor 300 may be referred to an example 320 of FIG. 3A.

Referring to FIG. 3A, the feature extractor 300 may be trained using learning data 321. For example, the learning data 321 may include images relative to faces of a plurality of users (or identification information of the plurality of users). For example, the learning data 321 may be referred to as a data set. For example, the feature extractor 300 may be trained based on a loss function 325 based on an output embedding vector 322 and a result embedding vector 323 obtained from each of the images of the learning data 321. For example, the loss function 325 may be used to train the feature extractor 300 so that vectors with the same identification information are positioned close to each other and vectors with different identification information are positioned far away in an embedding space (or a space defined by an embedding vector). In other words, the feature extractor 300 may be trained based on the loss function 325 so that the output embedding vector 322 relative to a specific user has a value similar to the result embedding vector 323 indicating the specific user. For example, the result embedding vector 323 may be referred to as a one-hot vector. For example, the loss function 325 may be used to train a backbone (or a weight, a backbone weight) of the feature extractor 300 via backpropagation.

According to an embodiment, the loss function 325 used for learning of the feature extractor 300 may be changed according to an orientation of a face of a user. For example, the loss function 325 may be referred to as an angle-aware loss function. For example, the loss function 325 may be defined by a rotation margin value and a reference margin value generated based on angle values (or rotation angle values) indicating the orientation. For example, the reference margin value may be used to distinguish between a plurality of users that may be identified by the feature extractor 300. For example, the reference margin value may have the same value with respect to the plurality of users (or a plurality of images including faces of the plurality of users).

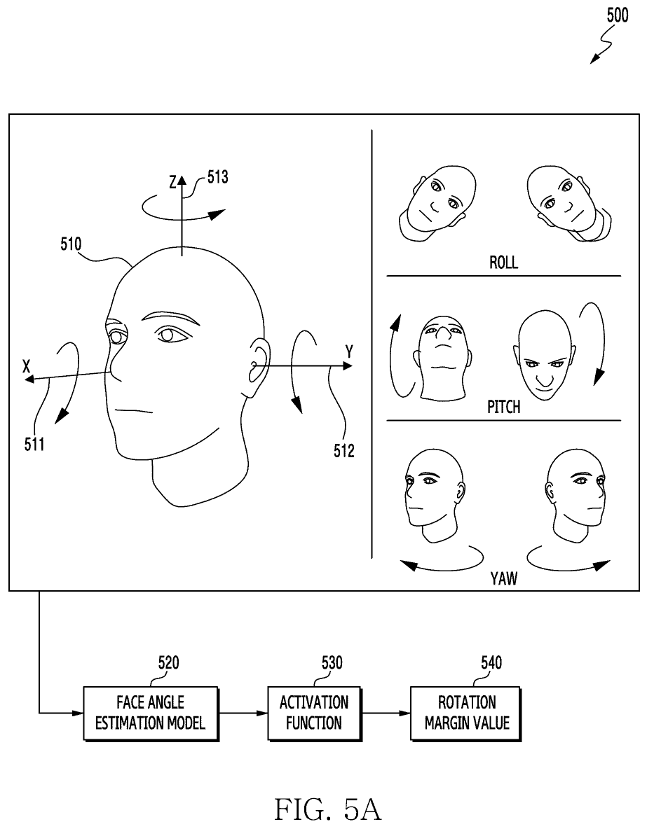

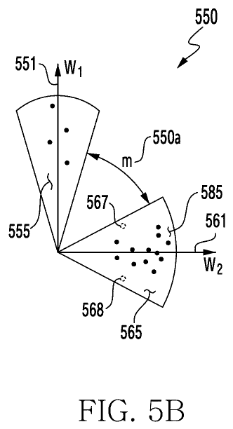

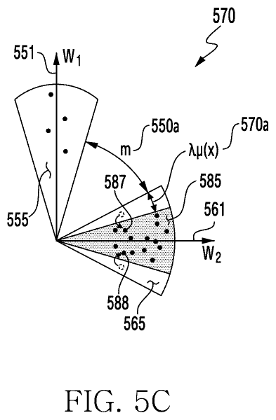

Specific content of the loss function 325 generated using the angle values indicating the orientation of the face will be described in FIGS. 5A and 6. Specific content of a method of distinguishing (or recognizing) a face of a user via the loss function 325 having a margin that is changed according to an orientation of the face of the user according to embodiments of the present disclosure will be described in FIGS. 5B and 6.

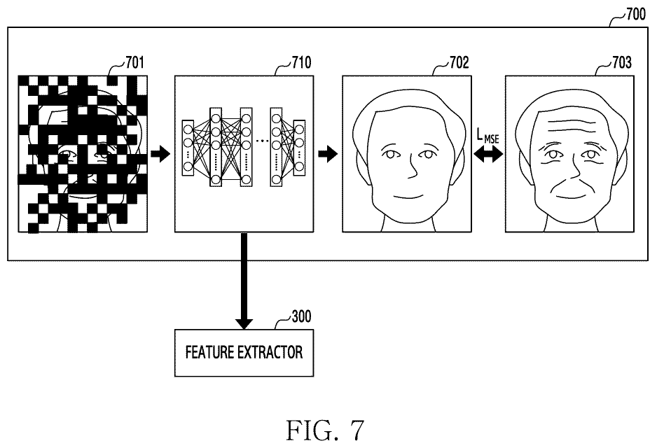

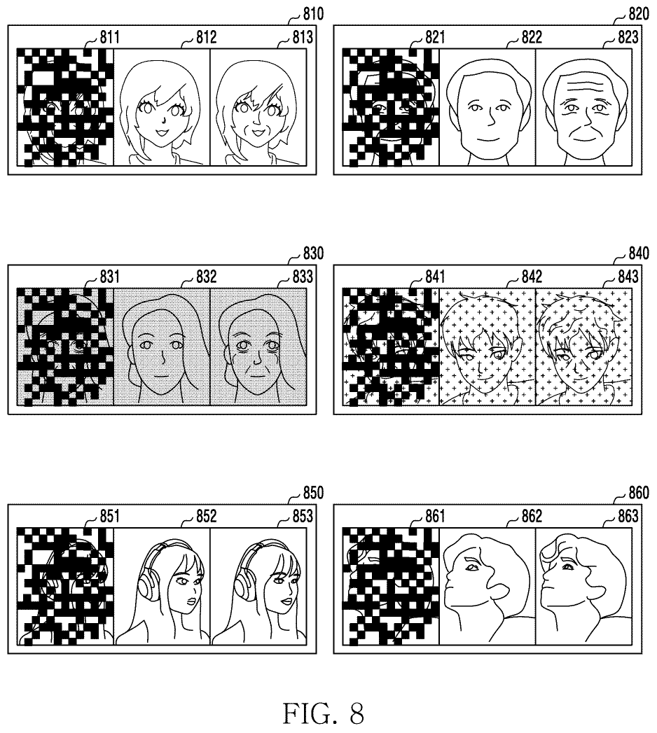

Although not illustrated in FIG. 3A, according to an embodiment, the backbone (or the weight) of the feature extractor 300 may be initialized. For example, the weight of the feature extractor 300 may be initialized based on a random weight. Alternatively, for example, the weight of the feature extractor 300 may be initialized based on a specific weight for effectively performing face recognition. Specific content related to this will be described in FIGS. 7 and 8.

FIG. 3B illustrates an example of a method of recognizing a user based on a face recognition model according to an embodiment.

FIG. 3B illustrates an example 350 of a method of recognizing (or identifying) the user (or the face of the user) based on the face recognition model 130 of FIG. 3A.

Referring to an example 360, an electronic device 101 may obtain a first image 361 and a second image 362. In FIG. 3B, for convenience of a description, the example 360 in which the electronic device 101 obtains the first image 361 and the second image 362, which are images, is illustrated, but an embodiment of the present disclosure is not limited thereto. For example, the electronic device 101 may also use a first embedding vector (or first identification information) extracted from the first image 361 and a second embedding vector (or second identification information) extracted from the second image 362. For example, the first image 361 may include a face of a first user. For example, the second image 362 may include a face of a second user.

According to an embodiment, the electronic device 101 may compare the first image 361 and the second image 362 with a third image 363. For example, the third image 363 may include the face of the second user. For example, the electronic device 101 may compare the first embedding vector (or the first identification information) with a third embedding vector (or third identification information) extracted from the third image 363. For example, the electronic device 101 may compare the second embedding vector (or the second identification information) with the third embedding vector (or the third identification information) extracted from the third image 363.

Referring to an example 370, the electronic device 101 may distinguish (or recognize) a first cluster 371 and a second cluster 372. For example, the electronic device 101 may classify the first image 361 into the first cluster 371, which is a set of data on the face of the first user, based on the face recognition model 130. In addition, the electronic device 101 may classify the second image 362 into the second cluster 372, which is a set of data on the face of the second user, based on the face recognition model 130.

Referring to the above description, the electronic device 101 may train the face recognition model 130 by classifying inputted data (e.g., the first image 361 and the second image 362). Thereafter, the electronic device 101 may recognize the face of the user by comparing a embedding vector (e.g., the embedding vector 302 of FIG. 3A) extracted from newly inputted data (e.g., the image 301 of FIG. 3A) with a reference embedding vector (e.g., the reference embedding vectors 310 of FIG. 3A).

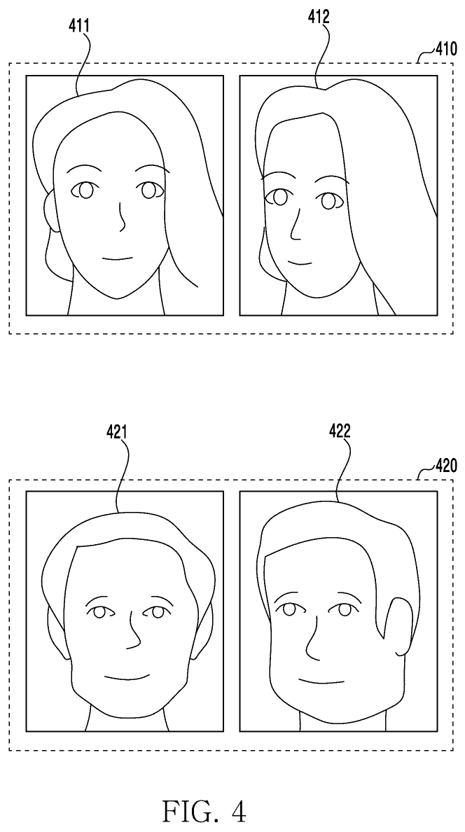

FIG. 4 illustrates an example of a method for recognizing a user based on a face recognition model according to an embodiment.

FIG. 4 illustrates an example of a method in which an electronic device 101 recognizes users based on a face recognition model 130. In FIG. 4, an example of a method in which the electronic device 101 recognizes a first user and a second user based on the face recognition model 130 is illustrated, but this is only for convenience of a description, and an embodiment of the present disclosure is not limited thereto.

According to an embodiment, the electronic device 101 may obtain a plurality of images 411, 412, 421, and 422. For example, the electronic device 101 may use the plurality of images 411, 412, 421, and 422 as an input to the face recognition model 130.

For example, the first image 411 may include a face of the first user. The face of the first user in the first image 411 may have (or indicate or face to) a first orientation. For example, the first orientation may indicate an orientation in which the face of the user faces to a front orientation. For example, the second image 412 may include the face of the first user. The face of the first user in the second image 412 may have a second orientation. For example, the second orientation may include an orientation in which the face of the user faces an orientation different from the front orientation.

For example, the third image 421 may include a face of the second user. The face of the second user in the third image 421 may have the first posture. For example, the fourth image 422 may include the face of the second user. The face of the second user in the fourth image 422 may have the second posture.

According to an embodiment, the electronic device 101 may output (or generate) identification information of a user from an image using the face recognition model 130.

For example, the electronic device 101 may output (or generate) first identification information of the first user from the first image 411 using the face recognition model 130. By using the face recognition model 130, the electronic device 101 may generate the first identification information by extracting a first embedding vector from the first image 411 and comparing the extracted first embedding vector with reference embedding vectors.

For example, the electronic device 101 may output (or generate) the first identification information of the first user from the second image 412 using the face recognition model 130. By using the face recognition model 130, the electronic device 101 may generate the first identification information by extracting a second embedding vector from the second image 412 and comparing the extracted second embedding vector with reference embedding vectors.

For example, the electronic device 101 may output (or generate) second identification information of the second user from the third image 421 using the face recognition model 130. By using the face recognition model 130, the electronic device 101 may generate the second identification information by extracting a third embedding vector from the third image 421 and comparing the extracted third embedding vector with reference embedding vectors.

For example, the electronic device 101 may output (or generate) the second identification information of the second user from the fourth image 422 using the face recognition model 130. By using the face recognition model 130, the electronic device 101 may generate the second identification information by extracting a fourth embedding vector from the fourth image 422 and comparing the extracted fourth embedding vector with reference embedding vectors.

Referring to the above description, the electronic device 101 may recognize a face of a user (or the user) from an image including the face of the user, using the face recognition model 130. Referring to an example 410, the electronic device 101 may recognize the face of the first user from the first image 411 and the second image 412. Referring to the example 420, the electronic device 101 may recognize the face of the second user from the third image 421 and the fourth image 422.

According to an embodiment, the face recognition model 130 may be trained to recognize a face of a user even when an orientation of the face of the user in an image is changed. For example, the face recognition model 130 may be trained using a loss function that is dependent (or variable) on an orientation of the face. For example, the loss function may be referred to as an angle-aware loss function. For example, the loss function may be used to accurately recognize the user of the face from the image even when the orientation of the face in the image has the second orientation different from the first orientation. In other words, the loss function may allocate (or set) a margin differently according to a degree of rotation from an orientation in which the face faces to the front orientation. Accordingly, the electronic device 101 may accurately recognize the user from the image including the face even when the orientation of the face does not face to the front orientation, using the face recognition model 130 trained by the loss function.

Hereinafter, in FIG. 5A, an example of the angle-aware loss function that is changed according to the orientation of the face is described. In addition, hereinafter, in FIG. 5B, an example of a method of recognizing a face based on each of the angle-aware loss function that is changed according to the orientation of the face and a loss function (e.g., the ArcFace) that is set regardless of the orientation of the face is described.

FIG. 5A illustrates an example of a loss function that is used for training a face recognition model and is changed according to an orientation of a face, according to an embodiment. FIGS. 5B and 5C illustrate examples of a method of recognizing a face of a user based on a face recognition model trained using a loss function that is changed according to an orientation of a face according to an embodiment.

FIG. 5A illustrates an example 500 for a method of generating an angle-aware loss function (e.g., the loss function 325 of FIG. 3A) that is used for learning of a face recognition model 130 of FIG. 3A and is changed according to a posture of a face in an image.

Referring to the example 500, an image 510 may include a face of a specific user. The face in the image 510 may face to a specific orientation. For example, the specific orientation may be determined based on rotation angle values indicating an angle changed from a reference orientation of the face. For example, the reference orientation may include a first orientation in which the face faces a front orientation. For example, the rotation angle values may include roll relative to the face, pitch relative to the face, and yaw relative to the face. For example, the roll may indicate a first angle rotated around an x-axis 511, which is an orientation in which the face faces. For example, the pitch may indicate a second angle rotated around a y-axis 512. For example, the yaw may indicate a third angle rotated around a z-axis 513.

According to an embodiment, a face angle estimation model 520 may calculate (or recognize or identify) rotation angles of the face in the image 510 from the image 510. For example, the face angle estimation model 520 may be included in the face recognition model 130. However, an embodiment of the present disclosure is not limited thereto. For example, the face angle estimation model 520 is a model different from the face recognition model 130 and may be included in memory 120 of an electronic device 101.

According to an embodiment, the face angle estimation model 520 may calculate an absolute value of each of rotation angles. For example, the face angle estimation model 520 may calculate a first absolute value relative to the roll, a second absolute value relative to the pitch, and a third absolute value relative to the yaw. For example, the face angle estimation model 520 may calculate the sum g(x) of the first absolute value, the second absolute value, and the third absolute value. For example, the sum g(x) may be defined as the following equation.

TABLE 2

g(x) = |rollₓ| + |pitchₓ| + |yawₓ|

The x may indicate an input vector (or an embedding vector of the image 510), the g(x) may indicate a function (hereinafter, a sum function) indicating a sum of absolute values of each of rotation angles, the |rollₓ| may indicate an absolute value of the roll, the |pitchₓ| may indicate an absolute value of the pitch, and the |yawₓ| may indicate an absolute value of the yaw.

According to an embodiment, an activation function σ 530 may indicate a function relative to the sum function g(x). For example, the activation function σ 530 may include a binary step activation function. For example, the activation function σ 530 may indicate a function that applies (or calculates) a specific value with respect to the sum function g(x) exceeding a threshold value.

According to an embodiment, a rotation margin value 540 may be calculated by a multiplication between the activation function σ 530 and an additional margin value. For example, a final penalty margin may indicate a sum of the rotation margin value 540 and a reference margin value m. For example, the final penalty margin may be defined as the following equation.

TABLE 3

m + λμ(x), (μ(x) = σ(g(x)))

The m may indicate a reference margin value, the λ may indicate an additional margin value, the μ(x) may indicate the activation function a 530 relative to the sum function g(x), and the λμ(x) may indicate the rotation margin value 540. For example, the additional margin value may be a designated constant. For example, the additional margin value may be determined according to the face angle estimation model 520. For example, the reference margin value m may be used to distinguish between a plurality of users. For example, the reference margin value m may have the same value with respect to the plurality of users (or a plurality of images including faces of the plurality of users).

For example, the sum of the rotation margin value 540 and the reference margin value m may be referred to as the final penalty margin. For example, the rotation margin value 540 may be changed according to a posture of the face of the user. The rotation margin value 540 may be used to calculate an angle-aware loss function (e.g., the loss function 325) used to train a feature extractor 300 of the face recognition model 130. The loss function that is changed according to an orientation of the face will be described through FIGS. 5B and 5C below.

FIG. 5B illustrates an example 550 of a method of recognizing a face of a user based on a face recognition model trained using a loss function (e.g., the ArcFace) that does not consider an orientation of the face. FIG. 5C illustrates an example 570 of a method of recognizing a face of a user based on the face recognition model 130 trained using an angle-aware loss function that considers an orientation of the face. Hereinafter, for convenience of a description, the loss function that does not consider the orientation of the face may be referred to as a first loss function, and the angle-aware loss function that considers the orientation of the face may be referred to as a second loss function.

Referring to the example 550 and the example 570, a first reference vector W₁ 551 may indicate a class (or identification information) of a first user, and a second reference vector W₂ 561 may indicate a class (or identification information) of a second user. In other words, as an embedding vector obtained from an image is closer to the first reference vectors W₁ 551, a face of the image may indicate a face of the first user. In addition, as the embedding vector obtained from the image is closer to the second reference vectors W₂ 561, the face of the image may indicate a face of the second user.

Referring to the example 550 of FIG. 5B, an electronic device 101 may train the face recognition model using the first loss function so that an embedding vector, when obtained from each of the plurality of images, is distinguished for each user. In a case of using the first loss function, a space between a first boundary 555 formed with respect to the first reference vectors W₁ 551 and a second boundary 565 formed with respect to the second reference vectors W₂ 561 may be defined as a reference margin value m 550a. In other words, the first loss function may distinguish users (or classes) by using the reference margin value m 550a. The first loss function may be defined as the following equation.

TABLE 4

${L}_{arcface} = - \frac{1}{N} {\sum }_{i = 1}^{N} log \frac{{e}^{s \cdot cos ( {θ}_{{y}_{i}} + m )}}{{e}^{s \cdot cos ( {θ}_{{y}_{i}} + m )} + {\sum }_{j = 1 , j \neq {y}_{i}}^{N} {e}^{s \cdot cos {θ}_{j}}}$

The L_{arcface} may indicate the first loss function removing an influence of vias from the ArcFace and using an angle between vectors, the N may indicate a batch (or a mini-batch) size (or the number of samples), the s may indicate a scale factor, the θⱼ may indicate an angle between a reference vector of a jth class, and an input vector, the θ_{yi} may indicate an angle between a reference vector of a yᵢ_{ₜₕ} class and an input vector, the y may indicate a class (or a label), and the m may indicate a reference margin value.

Referring to the above description, using the reference margin value 550a, the first loss function may position embedding vectors relative to the same user (or class) closely and position embedding vectors relative to different users (or classes) far away. However, the first loss function may not consider an orientation relative to faces of the same user. In a case of using the first loss function (or in a case of using the face recognition model trained based on the first loss function), the electronic device 101 may have difficulty to recognize a reference vector (e.g., the second reference vector W₂ 561) that is a learning target of a first embedding vector 567 and a second embedding vector 568. This may be because the first embedding vector 567 and the second embedding vector 568 are positioned close to the second boundary 565. In other words, in a case of using the first loss function, the electronic device 101 may apply the same margin (e.g., the reference margin value 550a) with respect to images including a face regardless of an orientation of the face. Accordingly, in a case that the electronic device 101 uses the first loss function, it may be difficult to recognize a learning object (or a user or a class) with respect to a face facing to a rotated orientation. In a case that a learning target is not accurately indicated with respect to the face facing to the rotated orientation, even when the electronic device 101 uses the face recognition model trained using the first loss function, a recognition rate relative to the face facing to the rotated orientation may be lowered.

Unlike this, referring to the example 570 of FIG. 5C, according to an embodiment, the electronic device 101 may train the face recognition model 130 using the second loss so that an embedding vector, when obtained from each of the plurality of images, is distinguished for each user. In this case, the second loss function may use a margin value (or a rotation margin value) considering a posture of a face of each of the plurality of images. In a case of using the second loss function, a space between the first boundary 555 formed with respect to the first reference vector W₁ 551 and the second boundary 565 formed with respect to the second reference vector W₂ 561 may be defined as the reference margin value m and 550a. In addition, a space between the first boundary 555 formed with respect to the first reference vector W₁ 551 and a third boundary 585 formed with respect to the second reference vector W₂ 561 may be defined as the sum (or a final penalty margin) of a rotation margin value λμ(x) 570a and the reference margin value m 550a. For example, the third boundary 585 may be used to induce (or cause) training with respect to a specific user (e.g., the second user) of the face by applying a weight (e.g., the rotation margin value λμ(x) 570a) to a face whose posture has been rotated.

In other words, the second loss function may distinguish the users (or the classes) using the reference margin value m 550a and may induce the face in the rotated orientation to be learned with respect to the specific user using the rotation margin value μμ(x) 570a. The second loss function may be defined as the following equation.

TABLE 5

$L = - \frac{1}{N} {\sum }_{i = 1}^{N} log \frac{{e}^{s \cdot cos ( {θ}_{{y}_{i}} + m + λμ ( x ) ) )}}{{e}^{s \cdot cos ( {θ}_{{y}_{i}} + m + λμ ( x ) )} + {\sum }_{j = 1 , j \neq {y}_{i}}^{N} {e}^{s \cdot cos {θ}_{j}}}$

The L may indicate the second loss function that easily induces a tilted face when training the face recognition model 130 (or the feature extractor 300) by applying a larger margin (or a penalty margin) as a posture change in the face increases, the N may indicate a batch (or a mini-batch) size (or the number of samples), the s may indicate a scale factor, the θⱼ is an angle between a reference vector of a jth class and an input vector, y is a class (or label), the ∂_{yi} may indicate an angle between a reference vector of a yᵢ class and an input vector, the y may indicate a class (or a label), the m may indicate a reference margin value, the μ(x) may indicate an activation function a relative to the sum function g(x), and the λ may indicate an additional margin value.

Referring to the above description, using the reference margin value 550a, the second loss function may position embedding vectors relative to the same user (or class) closely, and position embedding vectors relative to different users (or classes) far away. In addition, the second loss function may closely adjust a reference vector of the user of the face and embedding vectors of the face by applying a larger penalty value (e.g., the rotation margin value λμ(x) 570a) with respect to embedding vectors of the face with a tilted orientation (e.g., the second orientation).

Referring to the example 550 and the example 570, the first embedding vector 567 and the second embedding vector 568 may be changed to a third embedding vector 587 and a fourth embedding vector 588 as the second loss function is used. For example, the first embedding vector 567 may be changed to the third embedding vector 587 by the rotational margin value λμ(x) 570a of the second loss function. For example, the second embedding vector 568 may be changed to the fourth embedding vector 588 by the rotational margin value λμ(x) 570a of the second loss function. For example, the third embedding vector 587 and the fourth embedding vector 588 may be positioned in the third boundary 585 and positioned closer to the second reference vector W₂ 561 indicating the second user. Referring to the above description, compared to the first loss function, the second loss function may apply a larger margin (or a penalty margin) with respect to the embedding vector indicating the face of the rotated posture.

According to an embodiment, the electronic device 101 may train the face recognition model 130 using the third embedding vector 587 and the fourth embedding vector 588 in which a learning target is the second reference vector W₂ 561 by the rotation margin value λμ(x) 570a. The electronic device 101 using the trained face recognition model 130 may accurately recognize a user of a face even when an image including the face in a rotated orientation is obtained (or inputted). In other words, in a case that the electronic device 101 uses the face recognition model 130 trained based on the second loss function, a recognition rate for a tilted face may be improved.

FIG. 6 illustrates an example of an operation flow of a method of recognizing a face of a user based on a face recognition model trained using a loss function that is changed according to an orientation of the face according to an embodiment.

The electronic device of FIG. 6 may include the electronic device 101 of FIG. 1. At least one of operations of FIG. 6 may be performed by the electronic device 101 of FIG. 1. For example, at least one of the operations may be controlled by the processor 110 of FIG. 1. Each of the operations of FIG. 6 may be performed sequentially, but is not necessarily performed sequentially. For example, an order of each of the operations may be changed, and at least two operations may be performed in parallel.

The method of FIG. 6 may be used to train a face recognition model for recognizing a face of a user. For example, the face recognition model may include the face recognition model 130 of FIG. 3A. For example, the face recognition model 130 may be trained based on an angle-aware loss function (or the second loss function) according to an orientation of the face.

According to an embodiment, in an operation of FIG. 6, the electronic device 101 may obtain rotation angle values indicating an orientation of a face in an image. For example, the electronic device 101 may obtain the rotation angle values indicating the orientation of the face from the image of the user.

According to an embodiment, the electronic device 101 may obtain the rotation angle values using a face angle estimation model (e.g., the face angle estimation model 520 of FIG. 5A). For example, the face angle estimation model 520 may be included in the face recognition model 130. However, an embodiment of the present disclosure is not limited thereto. For example, the face angle estimation model 520 may be included in memory 120 of the electronic device 101.

For example, the rotation angle values may include roll relative to the face, pitch relative to the face, and yaw relative to the face. For example, the roll may indicate a first angle rotated around an x-axis in which the face faces. For example, the pitch may indicate a second angle rotated around a y-axis. For example, the yaw may indicate a third angle rotated around a z-axis.

According to an embodiment, the electronic device 101 may calculate an absolute value of each of rotation angles using the face angle estimation model 520. For example, the electronic device 101 may calculate a first absolute value relative to the roll, a second absolute value relative to the pitch, and a third absolute value relative to the yaw using the face angle estimation model 520. For example, the electronic device 101 may calculate the sum g(x) of the first absolute value, the second absolute value, and the third absolute value using the face angle estimation model 520.

According to an embodiment, in an operation 620, the electronic device 101 may generate an activation function a relative to the sum g(x) of the first absolute value relative to the roll, the second absolute value relative to the pitch, and the third absolute value relative to the yaw. For example, the activation function a may include a binary step activation function. For example, the activation function σ may indicate a function that applies (or calculates) a specific value with respect to a sum function g(x) exceeding a threshold value.

According to an embodiment, in an operation 630, the electronic device 101 may calculate a rotation margin value λμ(x)=λσ(g(x)) from a multiplication between the activation function a and an additional margin value λ. For example, a rotation margin value λμ(x) may be changed according to an orientation of the face of the user. The rotation margin value λμ(x) may be used to calculate a loss function used to train a feature extractor 300 of the face recognition model 130.

According to an embodiment, in an operation 640, the electronic device 101 may calculate the loss function based on the sum of the rotation margin value λμ(x) and a reference margin value m. For example, the reference margin value m may be used to distinguish between a plurality of users. For example, the reference margin value m may have the same value with respect to the plurality of users (or a plurality of images including faces of the plurality of users). For specific content on the loss function calculated based on the sum of the rotational margin value λμ(x) and the reference margin value m, Equation 5 described above may be referred to.

For example, using the reference margin value m, the loss function may be trained such that embedding vectors relative to the same user (or class) are close to each other, and embedding vectors relative to different users (or classes) are far away. In addition, the loss function may closely adjust the reference vector of the user of the face and the embedding vectors by applying a larger penalty value (e.g., the rotation margin value λμ(x)) with respect to embedding vectors of the face with a tilted orientation (e.g., the second orientation).

According to an embodiment, in an operation 650, the electronic device 101 may apply the loss function to a model. For example, the electronic device 101 may use the loss function to train the face recognition model 130. The electronic device 101 may accurately recognize the user of the face even when an image including the face in the tilted orientation is obtained (or inputted) by learning the face recognition model 130 using the loss function.

FIG. 7 illustrates an example of a face recognition model having a weight transitioned from a weight of a model trained using an image restored from an image indicating a portion of a face of a user according to an embodiment.

FIG. 7 illustrates an example 700 of a method of transitioning a weight of the pre-trained model to the face recognition model. For example, the face recognition model of FIG. 7 may include the face recognition model 130 of FIG. 3A. The pre-trained model may include a masked auto encoder (MAE) 710. For example, a feature extractor 300 of FIG. 7 may be included in the face recognition model 130.

According to an embodiment, the electronic device 101 may initialize the feature extractor 300. For example, the electronic device 101 may initialize the feature extractor 300 to perform face recognition more effectively. In this case, the electronic device 101 may initialize a weight of the feature extractor 300 by transitioning a weight of the pre-trained MAE 710.

According to an embodiment, the electronic device 101 may train the MAE 710 before initializing the weight of the feature extractor 300. For example, the electronic device 101 may use a first reference image 703 including a face of a user for learning of the MAE 710. For example, the electronic device 101 may generate a second reference image 701 from the first reference image 703. For example, the second reference image 701 may include a portion of the face of the user. For example, the second reference image 701 may indicate an image including a portion of the first reference image 703. In this case, the portion included in the second reference image 701 may have a designated value determined according to the feature extractor 300 (or the face recognition model 130). For example, the electronic device 101 may input the second reference image 701 to the MAE 710. For example, the electronic device 101 may generate an output image 702 restored from the second reference image 701 using the MAE 710.

According to an embodiment, the electronic device 101 may calculate a difference L_{MSE} between the output image 702 and the first reference image 703. For example, the difference L_{MSE} may be calculated using a difference between a vector value of the output image 702 and a vector value of the first reference image 703. Specific content on the difference L_{MSE} may be referred to in the following equation.

TABLE 6

${L}_{MSE} - \frac{1}{N} {\sum }_{i = 1}^{N} {( {y}_{i} - {\hat{y}}_{i} )}^{2}$

The L_{MSE} may indicate a difference between a restored (or a predicted) image (e.g., the output image 702) and a correct answer image (e.g., the first reference image 703), the N may indicate a batch (or a mini-batch) size (or the number of samples), the yᵢ may indicate a vector value of the correct answer image, and the ŷᵢ may indicate a vector value of the restored image.

Referring to the above description, the electronic device 101 may calculate the difference L_{MSE} and train the MAE 710 using the calculated difference L_{MSE}. For example, the electronic device 101 may train the MAE 710 via backpropagation relative to the difference L_{MSE}. Training the MAE 710 may include updating a weight of the MAE 710.

According to an embodiment, the electronic device 101 may transition the updated weight of the MAE 710 to the feature extractor 300. For example, the electronic device 101 may change (or update, adjust, train, or transition) the weight of the feature extractor 300 to the updated weight of the MAE 710.

Referring to the above description, the feature extractor 300 (or the face recognition model) may have a weight robust to a distortion such as a brightness change in an image including a face or a change in an orientation of the face by transitioning the weight of the MAE 710 trained using the intentionally removed second reference image 701.

FIG. 8 illustrates examples of an image indicating a portion of a face of a user, a restored image, and an image indicating the face of the user according to an embodiment.

FIG. 8 illustrates examples 810, 820, 830, 840, 850 and 860 of an image used for learning of the MAE 710 of FIG. 7. For example, an image indicating a portion of a face may indicate an input image (e.g., the second reference image 701 of FIG. 7). For example, the restored image may indicate a restored image (e.g., the output image 702 of FIG. 7). For example, the image indicating the face may indicate a correct answer image (e.g., the first reference image 703 of FIG. 7).

Referring to the example 810, an electronic device 101 may use images 811, 812, and 813 including a face of a woman for learning of the MAE 710. For example, the electronic device 101 may generate an input image 811 partially removed from a correct answer image 813 and may input the input image 811 to the MAE 710. Accordingly, the electronic device 101 may generate a restored image 812 restored from the input image 811. The restored image 812 is similar to the correct answer image 813, but may not be completely the same.

Referring to the example 820, the electronic device 101 may use images 821, 822, and 823 including a face of a man for learning of the MAE 710. For example, the electronic device 101 may generate an input image 821 partially removed from a correct answer image 823 and may input the input image 821 to the MAE 710. Accordingly, the electronic device 101 may generate a restored image 822 restored from the input image 821. The restored image 822 is similar to the correct answer image 823, but may not be completely the same.

Referring to the example 830, the electronic device 101 may use images 831, 832, and 833 including a face and having relatively dark brightness for learning of the MAE 710. For example, the electronic device 101 may generate an input image 831 partially removed from a correct answer image 833 and may input the input image 831 to the MAE 710. Accordingly, the electronic device 101 may generate a restored image 832 restored from the input image 831. The restored image 832 is similar to the correct answer image 833, but may not be completely the same.

Referring to the example 840, the electronic device 101 may use images 841, 842, and 843 including a face and having relatively bright brightness for learning of the MAE 710. For example, the electronic device 101 may generate an input image 841 partially removed from a correct answer image 843 and may input the input image 841 to the MAE 710. Accordingly, the electronic device 101 may generate a restored image 842 restored from the input image 841. The restored image 842 is similar to the correct answer image 843, but may not be completely the same.

Referring to the example 850, the electronic device 101 may use images 851, 852, and 853 including a face with an orientation tilted in a first orientation (e.g., right) for learning of the MAE 710. For example, the electronic device 101 may generate an input image 851 partially removed from a correct answer image 853 and may input the input image 851 to the MAE 710. Accordingly, the electronic device 101 may generate a restored image 852 restored from the input image 851. The restored image 852 is similar to the correct answer image 853, but may not be completely the same.

Referring to the example 860, the electronic device 101 may use images 861, 862, and 863 including a face with an orientation tilted in a second orientation (e.g., left) for learning of the MAE 710. For example, the electronic device 101 may generate an input image 861 partially removed from a correct answer image 863 and may input the input image 861 to the MAE 710. Accordingly, the electronic device 101 may generate a restored image 862 restored from the input image 861. The restored image 862 is similar to the correct answer image 863, but may not be completely the same.

Referring to the above description, the electronic device 101 may train the MAE 710 using various images illustrated in FIG. 8. The electronic device 101 may transition (or initialize) a weight of the MAE 710 trained based on the various images to a weight of a face recognition model 130 (or a feature extractor 300). The electronic device 101 may accurately recognize a face of a user even in an environment where a face in an image is not visible or difficult to recognize by using the face recognition model 130 (or the feature extractor 300) having the transitioned weight.

As described above, an electronic device may comprise memory storing instructions. The electronic device may comprise a processor operatively coupled to the memory. The instructions, when executed by the processor, may cause the electronic device to obtain an image including a face of a user. The instructions, when executed by the processor, may cause the electronic device to extract feature values from the obtained image using a face recognition model such that a weight of a masked auto encoder (MAE) trained with respect to faces including the face is transitioned. The instructions, when executed by the processor, may cause the electronic device to identify a reference embedding vector, among reference embedding vectors stored in the memory, corresponding to an embedding vector generated based on the extracted feature values. The instructions, when executed by the processor, may cause the electronic device to recognize the user corresponding to the reference embedding vector identified from the image. The face recognition model may be trained via a loss function calculated based on a reference margin value and a rotation margin value based on at least one rotation angle value indicating an orientation of the face.

According to an embodiment, the at least one rotation angle value may include roll relative to the face, pitch relative to the face, and yaw relative to the face.

According to an embodiment, the rotation margin value may be calculated based on an activation function relative to the sum of a first absolute value relative to the roll, a second absolute value relative to the pitch, and a third absolute value relative to the yaw.

According to an embodiment, the activation function may include a binary step activation function. The rotation margin value may be calculated based on a multiplication between an additional margin value and the activation function relative to the sum.

According to an embodiment, the reference margin value may be used to distinguish between a plurality of users. The reference margin value may be applied equally to a plurality of images including the face of the user.

According to an embodiment, the rotation margin value, in a case that the orientation is a first orientation such that the face faces a front orientation, may have a first value. The rotation margin value, in a case that the orientation is a second orientation in which the face faces an orientation different from the front orientation, may have a second value different from the first value.

According to an embodiment, the face recognition model may be further trained, in a case that the orientation is the first orientation, using the embedding vector to which the loss function calculated based on the reference margin value among the rotation margin value and the reference margin value is applied. The face recognition model may be further trained, in a case that the orientation is the second orientation, using the embedding vector to which the loss function calculated based on the sum of the rotation margin value and the reference margin value is applied.

According to an embodiment, a weight of the face recognition model may be changed as the weight of the MAE is transitioned. The MAE may be trained based on a difference between a first reference image including the face of the user among the faces, and an output image restored from a second reference image including a portion of the first reference image.

According to an embodiment, the weight of the MAE may be updated via backpropagation relative to the difference calculated based on a square of a difference vector value between a first vector value of the first reference image and a vector value of the second reference image.

As described above, a method performed by an electronic device may comprise obtaining an image including a face of a user. The method may comprise extracting feature values from the obtained image using a face recognition model such that a weight of a masked auto encoder (MAE) trained with respect to faces including the face is transitioned. The method may comprise identifying a reference embedding vector, among stored reference embedding vectors, corresponding to an embedding vector generated based on the extracted feature values. The method may comprise recognizing the user corresponding to the reference embedding vector identified from the image. The face recognition model may be trained via a loss function calculated based on a reference margin value and a rotation margin value based on at least one rotation angle value indicating an orientation of the face.

According to an embodiment, the at least one rotation angle value may include roll relative to the face, pitch relative to the face, and yaw relative to the face.

According to an embodiment, the rotation margin value may be calculated based on an activation function relative to the sum of a first absolute value relative to the roll, a second absolute value relative to the pitch, and a third absolute value relative to the yaw.

According to an embodiment, the activation function may include a binary step activation function. The rotation margin value may be calculated based on a multiplication between an additional margin value and the activation function relative to the sum.

According to an embodiment, the reference margin value may be used to distinguish between a plurality of users. The reference margin value may be applied equally to a plurality of images including the face of the user.

According to an embodiment, the rotation margin value, in a case that the orientation is a first orientation such that the face faces a front orientation, may have a first value. The rotation margin value, in a case that the orientation is a second orientation in which the face faces an orientation different from the front orientation, may have a second value different from the first value.

According to an embodiment, the face recognition model may be further trained, in a case that the orientation is the first orientation, using the embedding vector to which the loss function calculated based on the reference margin value among the value and the reference margin value is applied. The face recognition model may be further trained, in a case that the orientation is the second orientation, using the embedding vector to which the loss function calculated based on the sum of the value and the reference margin value is applied.

According to an embodiment, a weight of the face recognition model may be changed as the weight of the masked auto encoder (MAE) is transitioned. The MAE may be trained based on a difference between a first reference image including the face of the user among the faces, and an output image restored from a second reference image including a portion of the first reference image.

According to an embodiment, the weight of the MAE may be updated via backpropagation relative to the difference calculated based on a square of a difference vector value between a first vector value of the first reference image and a vector value of the second reference image.

As described above, in a computer readable storage medium storing one or more programs, the one or more programs, when executed by a processor of an electronic device, may comprise instructions to cause the electronic device to obtain an image including a face of a user. The one or more programs, when executed by the processor, may comprise instructions to cause the electronic device to extract feature values from the obtained image using a face recognition model such that a weight of a masked auto encoder (MAE) trained with respect to faces including the face is transitioned. The one or more programs, when executed by the processor, may comprise instructions to cause the electronic device to identify a reference embedding vector, among stored reference embedding vectors, corresponding to an embedding vector generated based on the extracted feature values. The one or more programs, when executed by the processor, may comprise instructions to cause the electronic device to recognize the user corresponding to the reference embedding vector identified from the image. The face recognition model may be trained via a loss function calculated based on a reference margin value and a rotation margin value based on at least one rotation angle value indicating an orientation of the face.

As described above, a method of training a model for recognizing a face of a user may comprise obtaining rotation angle values indicating an orientation of the face in an image of the user. The rotation angle values may include roll relative to the face, pitch relative to the face, and yaw relative to the face. The method may comprise generating an activation function relative to the sum of a first absolute value relative to the roll, a second absolute value relative to the pitch, and a third absolute value relative to the yaw. The method may comprise calculating a rotation margin value from a multiplication between the generated activation function relative and an additional margin value. The method may comprise calculating a loss function based on the sum of the rotation margin value and a reference margin value. The method may comprise applying the loss function to the model.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
memory storing instructions; and
a processor operatively coupled to the memory,
wherein the instructions, when executed by the processor, cause the electronic device to:
obtain an image including a face of a user,
extract feature values from the obtained image using a face recognition model such that a weight of a masked auto encoder (MAE) trained with respect to faces including the face of the user is transitioned;
identify a reference embedding vector, among reference embedding vectors stored in the memory, corresponding to an embedding vector generated based on the extracted feature values; and
recognize the user corresponding to the reference embedding vector identified from the image,
wherein the face recognition model is trained via a loss function calculated based on a reference margin value and a rotation margin value based on at least one rotation angle value indicating an orientation of the face of the user.

2. The electronic device of claim 1, wherein the at least one rotation angle value includes roll relative to the face, pitch relative to the face, and yaw relative to the face.

3. The electronic device of claim 2, wherein the rotation margin value is calculated based on an activation function relative to the sum of a first absolute value relative to the roll, a second absolute value relative to the pitch, and a third absolute value relative to the yaw.

4. The electronic device of claim 3, wherein the activation function includes a binary step activation function, and
wherein the rotation margin value is calculated based on a multiplication between an additional margin value and the activation function relative to the sum.

5. The electronic device of claim 4, wherein the reference margin value is used to distinguish between a plurality of users, and
wherein the reference margin value is applied equally to a plurality of images including the face of the user.

6. The electronic device of claim 1, wherein the rotation margin value, in a case that the orientation is a first orientation such that the face faces a front orientation, has a first value, and
wherein the rotation margin value, in a case that the orientation is a second orientation in which the face faces an orientation different from the front orientation, has a second value different from the first value.

7. The electronic device of claim 6, wherein the face recognition model is further trained, in a case that the orientation is the first orientation, using the embedding vector to which the loss function calculated based on the reference margin value among the rotation margin value and the reference margin value is applied, and
wherein the face recognition model is further trained, in a case that the orientation is the second orientation, using the embedding vector to which the loss function calculated based on the sum of the rotation margin value and the reference margin value is applied.

8. The electronic device of claim 1, wherein a weight of the face recognition model is changed as the weight of the MAE is transitioned, and
wherein the MAE is trained based on a difference between a first reference image including the face of the user among the faces, and an output image restored from a second reference image including a portion of the first reference image.

9. The electronic device of claim 8, wherein the weight of the MAE is updated via backpropagation relative to the difference calculated based on a square of a difference vector value between a first vector value of the first reference image and a vector value of the second reference image.

10. A method performed by an electronic device, comprising:
obtaining an image including a face of a user,
extracting feature values from the obtained image using a face recognition model such that a weight of a masked auto encoder (MAE) trained with respect to faces including the face of the user is transitioned;
identifying a reference embedding vector, among stored reference embedding vectors, corresponding to an embedding vector generated based on the extracted feature values; and
recognizing the user corresponding to the reference embedding vector identified from the image,
wherein the face recognition model is trained via a loss function calculated based on a reference margin value and a rotation margin value based on at least one rotation angle value indicating an orientation of the face of the user.

11. The method of claim 10, wherein the at least one rotation angle value includes roll relative to the face, pitch relative to the face, and yaw relative to the face.

12. The method of claim 11, wherein the rotation margin value is calculated based on an activation function relative to the sum of a first absolute value relative to the roll, a second absolute value relative to the pitch, and a third absolute value relative to the yaw.

13. The method of claim 12, wherein the activation function includes a binary step activation function, and
wherein the rotation margin value is calculated based on a multiplication between an additional margin value and the activation function relative to the sum.

14. The method of claim 13, wherein the reference margin value is used to distinguish between a plurality of users, and
wherein the reference margin value is applied equally to a plurality of images including the face of the user.

15. The method of claim 10, wherein the rotation margin value, in a case that the orientation is a first orientation such that the face faces a front orientation, has a first value, and
wherein the rotation margin value, in a case that the orientation is a second orientation in which the face faces an orientation different from the front orientation, has a second value different from the first value.

16. The method of claim 15, wherein the face recognition model is further trained, in a case that the orientation is the first orientation, using the embedding vector to which the loss function calculated based on the reference margin value among the value and the reference margin value is applied, and
wherein the face recognition model is further trained, in a case that the orientation is the second orientation, using the embedding vector to which the loss function calculated based on the sum of the value and the reference margin value is applied.

17. The method of claim 10, wherein a weight of the face recognition model is changed as the weight of the MAE is transitioned, and
wherein the MAE is trained based on a difference between a first reference image including the face of the user among the faces, and an output image restored from a second reference image including a portion of the first reference image.

18. The method of claim 17, wherein the weight of the MAE is updated via backpropagation relative to the difference calculated based on a square of a difference vector value between a first vector value of the first reference image and a vector value of the second reference image.

19. A computer readable storage medium storing one or more programs, wherein the one or more programs, when executed by a processor of an electronic device, comprise instructions to cause the electronic device to:
obtain an image including a face of a user,
extract feature values from the obtained image using a face recognition model such that a weight of a masked auto encoder (MAE) trained with respect to faces including the face of the user is transitioned;
identify a reference embedding vector, among stored reference embedding vectors, corresponding to an embedding vector generated based on the extracted feature values; and
recognize the user corresponding to the reference embedding vector identified from the image,
wherein the face recognition model is trained via a loss function calculated based on a reference margin value and a rotation margin value based on at least one rotation angle value indicating an orientation of the face of the user.

20. The non-transitory computer readable storage medium of claim 19, wherein the at least one rotation angle value includes roll relative to the face, pitch relative to the face, and yaw relative to the face.
